(19) United States
(12) Patent Application Publication
(10) Pub. No.: US 2011/0207343 A1
(43) Pub. Date: Aug. 25, 2011

(54) CONTACT-TYPE ELECTRONIC INSPECTION MODULE

(76) Inventor: YUNG-CHI TSAI, Taipei City (TW)

(21) Appl. No.: 12/710,630

(22) Filed: Feb. 23, 2010

(51) Int. Cl. H01R 12/00

(52) U.S. Cl. 439/66

(57) ABSTRACT

A contact-type electronic inspection module includes a carrying base, a plurality of terminal holes formed on the carrying base, and a plurality of conductive terminals coupled into the terminal holes respectively. Both ends of the conductive terminal are exposed from upper and lower sides of the carrying base. The conductive terminal includes an elastic pillar, and one or more electric conductive filaments buried in the middle of the elastic pillar, and the electric conductive filament includes an elastic portion formed at the middle and two conductive portions on both ends and exposed from both ends of the elastic pillar respectively, such that the contact-type electronic inspection module can be used for inspecting electronic products to achieve the effects of preventing the conductive terminals from being worn out or damaged, swapping or replacing the conductive terminals, and protecting the contact points of the circuit and enhance the electric conductivity.

### FIELD OF THE INVENTION

The present invention relates to a contact-type electronic inspection module, in particular to a contact-type electronic inspection module applied in contact-type integrated circuits (IC) and other electronic product inspection equipments.

### BACKGROUND OF THE INVENTION

In general, integrated circuits (IC) and other electronic products need to go through a number of tests or inspections to assure the yield rate of the products. The inspection of the integrated circuits (IC) and electronic products is mainly divided into non-contact inspection and contact inspection, and the non-contact inspection applies optical equipments for the inspection, and the contact inspection places the integrate circuits (IC) or electronic products on an inspection device and contacts a probe of the inspection device and a contact point of the integrate circuits (IC) or electronic products to obtain inspection data and assure product quality.

To achieve the effect of using a contact-type inspection device for various different integrated circuits (IC) and electronic products, related manufacturers adopt a contact-type inspection device (or module). The conventional contact-type inspection device as shown in FIG. 1 comprises a carrying base 10 in a rectangular shape, a plurality of through holes 101 arranged in a specific form on the carrying base 10, a plurality of metal balls 20 implanted into each through hole 101, an upper conductive portion 30 and a lower conductive portion 40 disposed at an upper end and a lower end of the through hole 101 respectively, a metal film 301 coated on an end surface of the upper conductive portion 30, and an electric conductive plastic film 401 coated on an end surface of the lower conductive portion 40. However, the metal film 301 of such conventional contact-type inspection device may be worn out or damaged easily, since the metal film 301 and the contact point of the integrate circuit (IC) and the other electronic product are used for the contact. Furthermore, if the metal film 301 is worn out or damage after being used for a while, it is difficult to repair or replace the metal film 301, and thus it is necessary to replace the whole set of the inspection device, and such arrangement results in a waste of resources and incurring an increased inspection cost. The plurality of metal balls 20 used for connecting the upper and lower conductive portions 30, 40 may create a number of gaps, giving rise to a low electric conductivity and a poor reliability of the inspection.

With reference to FIG. 2 for another conventional contact-type inspection device, a stamped metal probe 50 is coupled into a through hole 101 of a carrying base 10, such that an upper end 501 of each metal probe 50 is protruded from the upper and lower ends of the carrying base 10, and the lower end 502 is connected to an inspection device (such as a computer). Although the upper end 501 of such metal probe 50 will not be worn out or damaged easily and can be replaced conveniently, the coefficient of elasticity of the metal probe 50 is low and the structural design is poor. As a result, the contact point of the integrate circuit (IC) and the other electronic product may be worn out or damaged easily. For example, the coating used for enhancing the electric connection is worn out or damaged easily, or even worse, the contact point of the integrate circuit (IC) is worn out or damaged. Obviously, the aforementioned conventional contact-type inspection devices applied in integrate circuits (IC) and other electronic products require improvements.

Therefore, it is an important subject for the present invention to disclose a contact-type electronic inspection module applied in an inspection procedure of integrated circuits (IC) and other electronic products to achieve the effects of preventing the conductive terminals of the electronic inspection module from being worn out or damaged, providing a convenient way of replacing or repairing the conductive terminals, protecting the contact point of the integrate circuit (IC) and the other electronic product, and improving the electric conductivity.

### SUMMARY OF THE INVENTION

In view of the aforementioned shortcomings of the prior art, the inventor of the present invention based on years of experience in the related industry to conduct extensive researches and experiments, and finally developed a contact-type electronic inspection module, in hope of achieving the effects of preventing the conductive terminal from being worn out or damaged easily, detaching and replacing the conductive terminal conveniently, protecting the contact point of the integrate circuits (IC) and the other electronic product, and improving the electric conductivity.

Therefore, it is a primary objective of the present invention to overcome the aforementioned shortcomings and deficiencies of the prior art by providing a contact-type electronic inspection module in accordance with the present invention.

To achieve the foregoing objectives, the present invention provides a contact-type electronic inspection module with a structural design comprising a carrying base and a plurality of conductive terminals, wherein the conductive terminals having an excellent coefficient of elasticity are provided for contacting the contact points of integrated circuits (IC) and other electronic products, and a latch structure is provided for separating the carrying base to achieve the effects of preventing the conductive terminal from being worn out or damaged easily, swapping or replacing the conductive terminal conveniently, protecting the contact point of the integrate circuit (IC) and the other electronic product, and improving the electric conductivity.

To achieve the foregoing objective, the present invention provides a contact-type electronic inspection module comprising: a carrying base, having a plurality terminal holes formed thereon; and a plurality of conductive terminals coupled to the terminal holes respectively, and both ends of the conductive terminal being exposed from upper and lower sides of the carrying base, characterized in that the conductive terminal includes an elastic pillar, and one or more electric conductive filaments buried in the middle of the elastic pillar, and the electric conductive filament includes an elastic portion disposed at a middle section of the electric conductive filament, and two conductive portions disposed at both ends of the electric conductive filament and exposed from both ends of the elastic pillar respectively.

The elastic portion of the electric conductive filament of the conductive terminal has a spiral structure, and the conductive portions are plates bent from both ends of the elastic pillar respectively, and the elastic pillar of the conductive terminal is made of a silicone-based material or a polymer material, and the elastic pillar of the conductive terminal is a pillar having an upper end surface, a lower end surface and a lateral surface, wherein the upper end surface is exposed from a top side of the carrying base, and the lower end surface is exposed from a bottom side of the carrying base, and a protrusion is formed on the lateral surface and latched into the terminal hole of the carrying base, such that the conductive portions at both ends of the electric conductive filament are exposed from the upper end surface and the lower end surface of the elastic pillar respectively. In addition, each terminal hole of the carrying base has an inwardly retracted step surface disposed proximate to the upper end, and the lower end of the protrusion of the elastic pillar is abutted against the step surface of the lower end, and the top side of the carrying base includes a fixing element, and the fixing element includes a through hole corresponding to the terminal hole, such that the upper end surface of the elastic pillar can be passed through the through hole and exposed from the top side of the fixing element, and the edge of the through hole is abutted against the upper end of the protrusion of the elastic pillar, and the top side of the carrying base has a groove for fixing the fixing element into the groove, and the top side of the carrying base has a positioning protrusion, and the fixing element has a positioning recession coupled to the positioning protrusion.

Therefore the contact-type electronic inspection module of the present invention can achieve the effects of preventing the conductive terminal from being worn out or damaged easily, swapping and replacing the conductive terminal conveniently, protecting the contact points of the integrate circuits (IC) and the other electronic products, and improving the electric conductivity.

### BRIEF DESCRIPTION OF THE DRAWINGS

FIG. 1 is a schematic view of a conventional contact-type inspection device;

FIG. 2 is a schematic view of another conventional contact-type inspection device;

FIG. 3 is a perspective view of a contact-type electronic inspection module in accordance with a preferred embodiment of the present invention;

FIG. 4 is a cross-sectional view of a conductive terminal in accordance with a preferred embodiment of the present invention;

FIG. 5 is an exploded view of a contact-type electronic inspection module in accordance with a preferred embodiment of the present invention;

FIG. 6 is a side view of a contact-type electronic inspection module in accordance with a preferred embodiment of the present invention;

FIG. 7 is an enlarged view of Section A of FIG. 6;

FIG. 8 is an exploded side view of a contact-type electronic inspection module in accordance with a preferred embodiment of the present invention;

FIG. 9 is an enlarged view of Section B of FIG. 7;

FIG. 10 is a schematic view of an application of a contact-type electronic inspection module in accordance with a preferred embodiment of the present invention; and

FIG. 11 is an enlarged view of Section C of FIG. 10.

### DESCRIPTION OF THE PREFERRED EMBODIMENTS

To make it easier for the examiner to understand the objects, characteristics and effects of this invention, we use preferred embodiments together with the attached drawings for the detailed description of the invention as follows.

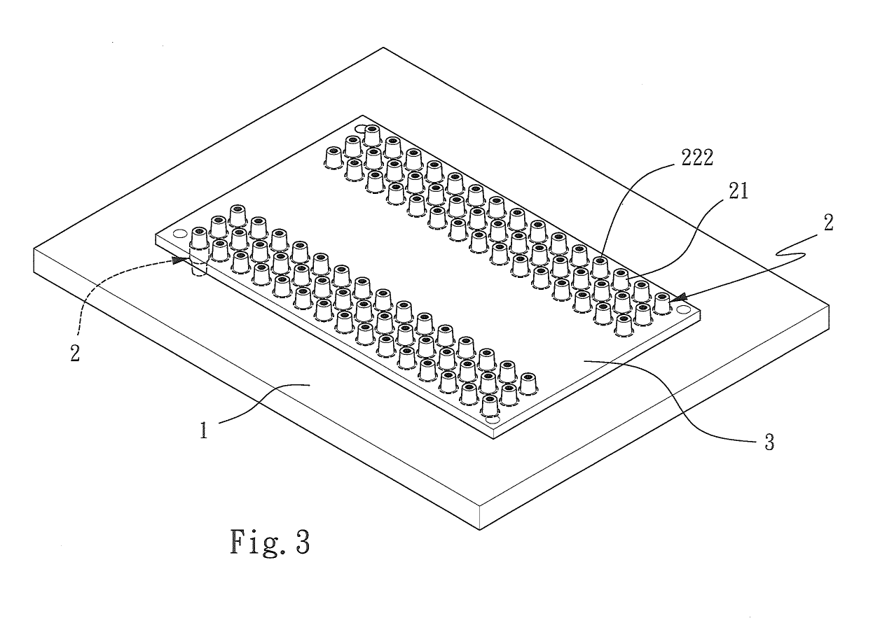

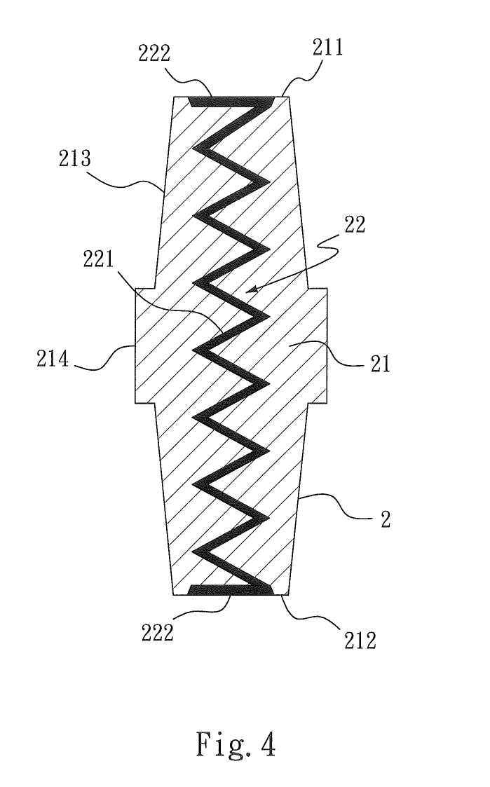

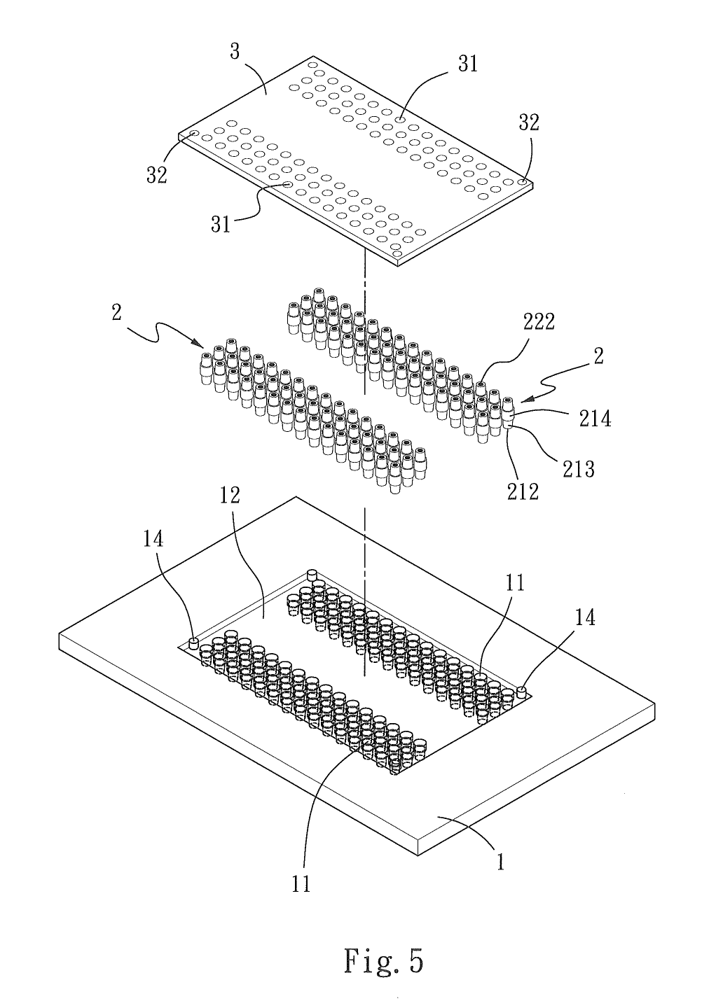

With reference to FIGS. 3 to 5 for a contact-type electronic inspection module in accordance with a preferred embodiment of the present invention, the contact-type electronic inspection module comprises: a carrying base 1, being an insulating base in a rectangular shape or any other shape, a plurality of terminal holes 11 arranged in rows on the carrying base 1, wherein the terminal holes 11 are arranged on both corresponding sides of the carrying base 1 or arranged in another geometric shape; and a plurality of conductive terminals 2 coupled into the terminal holes 11 respectively, such that both ends of the conductive terminal 2 are exposed from both top and bottom sides of the carrying base 1 respectively, characterized in that the conductive terminal 2 as shown in FIG. 4 includes an elastic pillar 21, and one or more elastic pillar 21 vertically buried in the middle of the electric conductive filament 22, and the electric conductive filament 22 includes an elastic portion 221 at a middle section, and a conductive portion 222 disposed separately at both ends, such that the conductive portions 222 at both ends are exposed from both ends of the elastic pillar 21 for constituting the contact-type electronic inspection module. The integrated circuits (IC) and other electronic products are placed on the carrying base 1, such that the contact points of the integrated circuits (IC) and the other electronic products are in contact with the upper conductive portions 222 of the conductive terminal 2, and then the lower conductive portion 222 of the conductive terminal 2 is connected to an electronic inspection device for carrying out a contact-type inspection procedure to assure the quality yield rate.

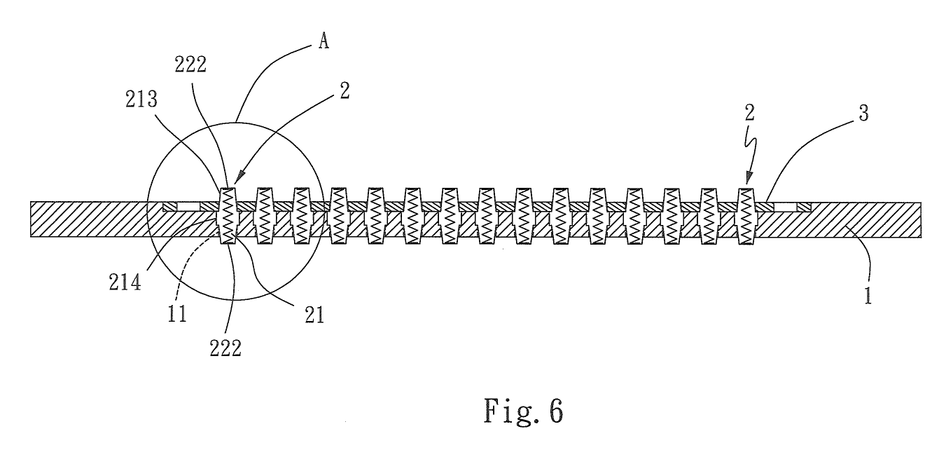

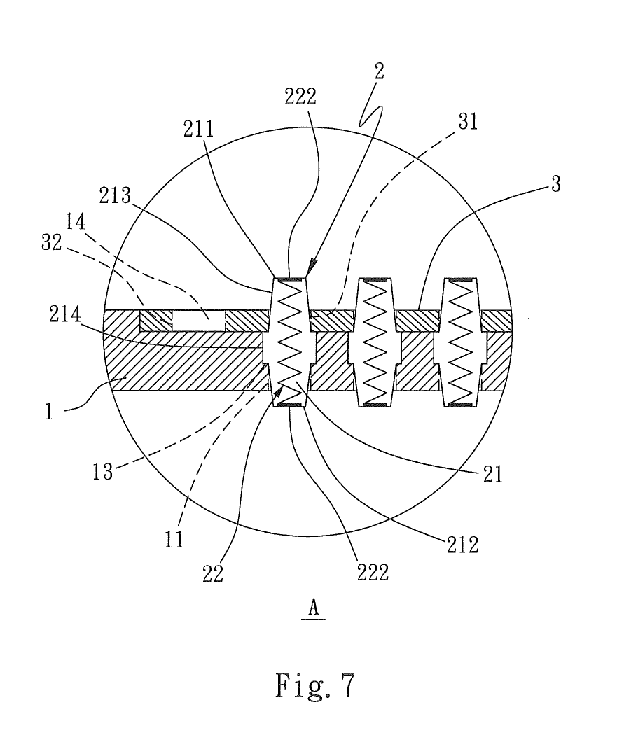

In FIG. 4, a preferred embodiment of the present invention improves the coefficient of elasticity of the conductive terminal 2 by designing the elastic portion 221 of the electric conductive filament 22 of the conductive terminal 2 into a spiral structure or a repeatedly bent structure, such that the elastic portion 221 can be extended or contracted together with the elastic pillar 21. The conductive portions 222 at both ends of the electric conductive filament 22 of the conductive terminal 2 are plates bent from both ends of an elastic pillar 21 respectively, or any other structure that can be used for an electric connection, wherein the electric conductive filament 22 is made of gold (Au), silver (Ag), copper (Cu) or their alloy having a high electric conductivity and a low resistance. In addition, the elastic pillar 21 of the conductive terminal 2 has a coefficient of elasticity higher than that of a silicone-based material, a polymer material, or another elastic material. In FIGS. 6 and 7, the contact-type electronic inspection module in accordance with a preferred embodiment of the present invention is characterized in that the elastic pillar 21 of the conductive terminal 2 is a pillar in a circular shape or another geometric shape and having an upper end surface 211, a lower end surface 212 and a lateral surface 213, and the upper end surface 211 is exposed from a top side of the carrying base 1, and the lower end surface 212 is exposed from a bottom side of the carrying base 1, and the lateral surface 213 includes a protrusion 214 latched into the terminal holes 11 of the carrying base 1, and the conductive portions 222 at both ends of the electric conductive filament 22 are exposed from the upper end surface 211 and the lower end surface 212 of the elastic pillar 21 respectively and electrically coupled to the contact points of the integrated circuits (IC) and the other electronic products as well as the electronic inspection device.

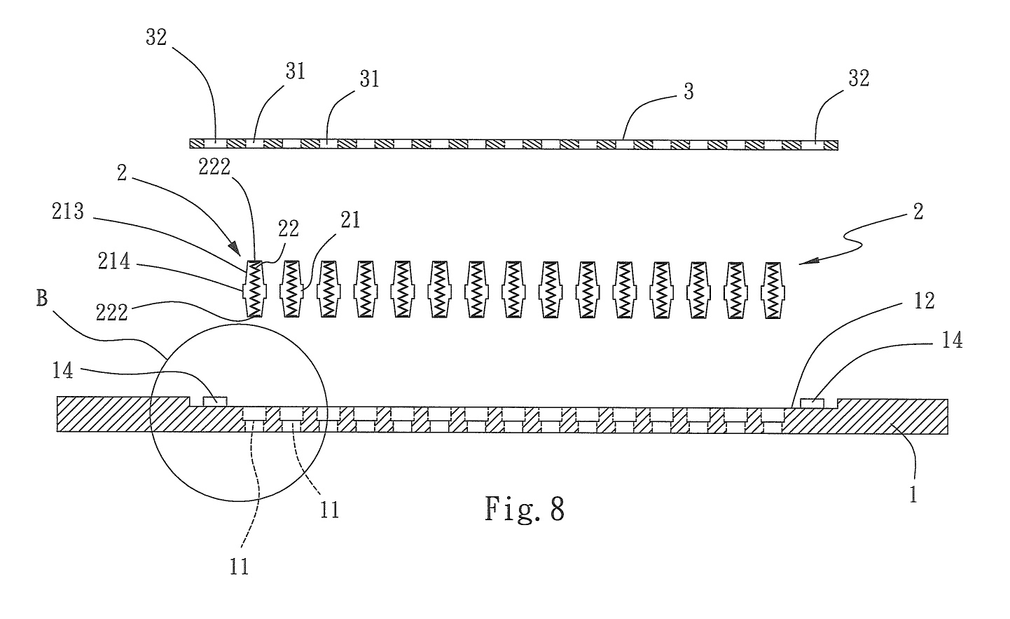

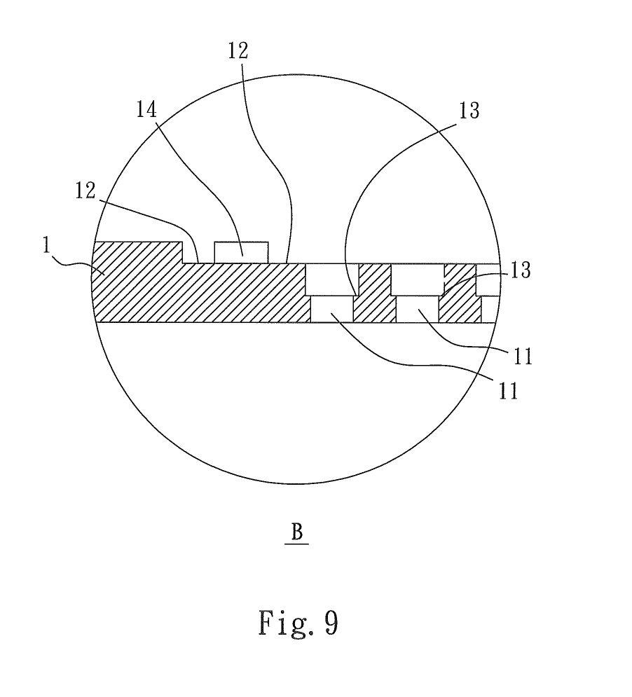

In FIGS. 7 to 9, a preferred embodiment the present invention facilitates the process of replacing the conductive terminal 2 of the carrying base 1 by designing an inwardly retracted step surface 13 disposed at the terminal hole 11 of the carrying base 1 and proximate to the upper end, such that the lower end of the protrusion 214 of the elastic pillar 21 of the conductive terminal 2 is abutted against the step surface 13. The carrying base 1 includes a fixing element 3 in a rectangular plate shape or another shape, and the fixing element 3 includes a through hole 31 corresponding to each terminal hole 11, such that an upper section of the elastic pillar 21 of the conductive terminal 2 is passed through the through hole 31, and the upper end surface 211 and the conductive portion 222 of the electric conductive filament 22 are exposed from the top side of the fixing element 3, and the edge of the through hole 31 is abutted against the upper end of the protrusion 214 of the elastic pillar 21 to fix the conductive terminal 2 into each terminal holes 11. The carrying base 1 has a groove 12 formed thereon, such that the terminal holes 11 can be formed in the groove 12 for fixing the fixing element 3 into the groove 12. To fix and connect the carrying base 1 and the fixing element 3 precisely, the carrying base 1 further includes at least one positioning protrusion 14 which is a cylindrical pillar, and the fixing element includes at least one positioning recession 32 coupled to the positioning protrusion 14, wherein the positioning recession 32 can be a circular hole matched with the cylindrical pillar.

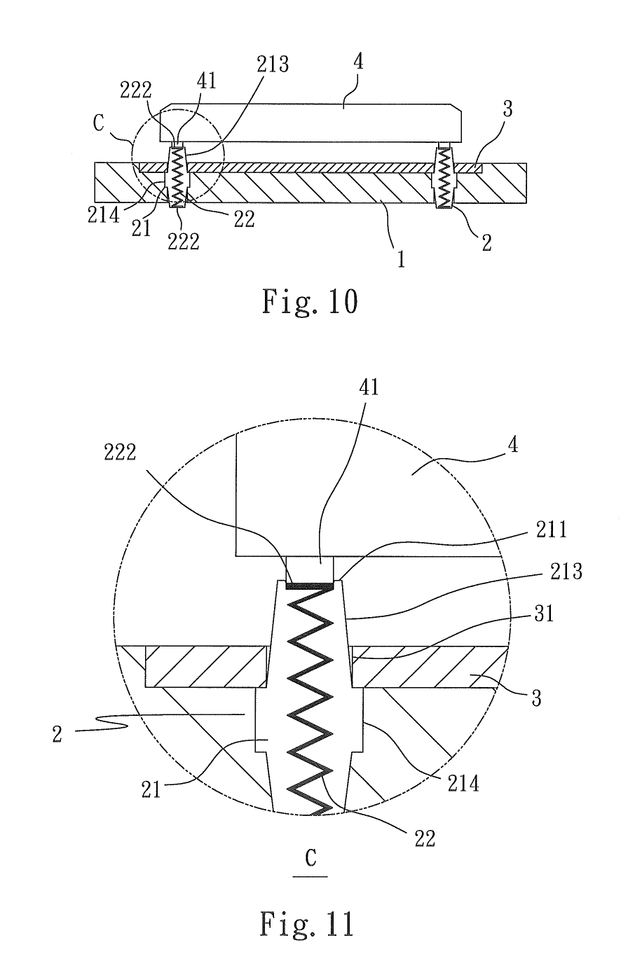

With the aforementioned design of the contact-type electronic inspection module of the present invention applied in a contact inspection device of an integrated circuit (IC) and another electronic product as shown in FIGS. 10 and 11, the packaged integrate circuit (IC) 4 or the other electronic product is placed on the carrying base 1, such that a contact point 41 of the integrate circuit (IC) 4 is electrically coupled to a conductive portion 222 at the upper end of the electric conductive filament 22 of the conductive terminal 2, and the conductive portion 222 at the lower end of the electric conductive filament 221 is connected to an inspection device (such as a computer) for carrying out a contact-type inspection procedure of the integrate circuit (IC) 4 and the other electronic product.

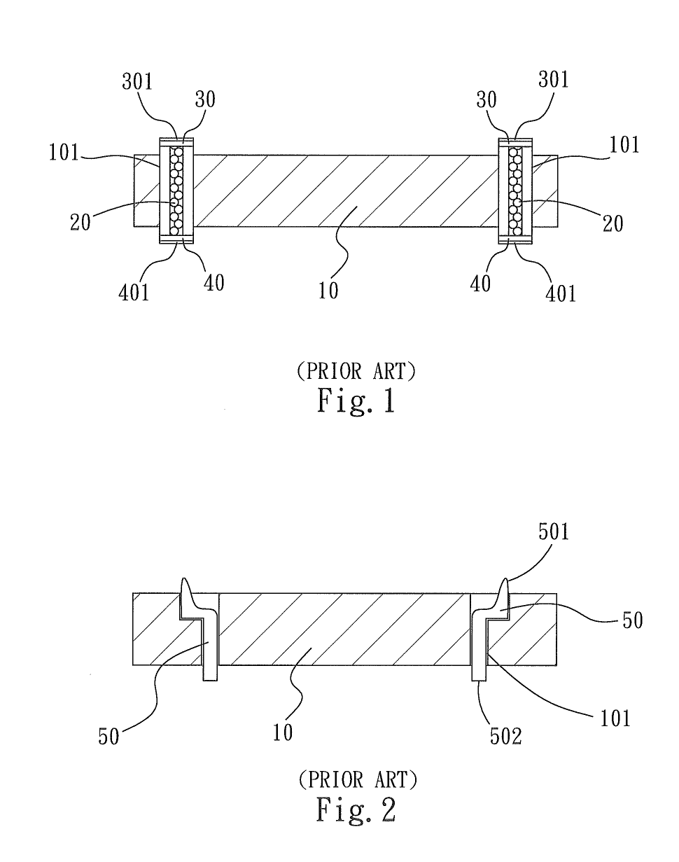

Since the elastic pillar 21 of the conductive terminal 2 of the present invention is made of a silicone-based material or a polymer material having a high coefficient of elasticity, therefore contracting and buffering effects can be achieved when the upper end surface 211 of the conductive terminal 2 and the conductive portion 222 at the upper end of the electric conductive filament 22 are in contact with the contact point 41 of the integrate circuit (IC) 4 or the other electronic product, so as to reduce the impact force produced when an operator or an automatic machine disposes the integrate circuit (IC) 4, and prevent the conductive portion 222 at the upper end of the electric conductive filament 22 from being worn out or damaged easily, and also prevent the conductive terminal 2 or the conductive portion 222 from wearing out or damaging the contact point 41 of the integrate circuit (IC) 4. In FIG. 11, the present invention allows the contact surface 211 of the elastic body 21 of the conductive terminal 2 to cover, contact and fix the contact point 41 of the integrate circuit (IC) 4 to achieve a good electric connection effect. The present invention adopts gold (Au), silver (Ag), copper (Cu) or their alloys to produce the electric conductive filament 22 as an electric conductive medium to overcome the drawback of a prior art having a gap as shown in FIG. 1 in order to achieve the effects of reducing the resistance, improving the electric conductivity, assuring the accuracy and reliability of the inspection data, reducing possible errors occurred in a functional testing procedure, and avoid defectives introduced to the market. In addition, the present invention includes a structural design of replaceable conductive terminals 2, such that if it is necessary to replace any conductive terminal 2, the fixing element 3 can be removed easily first before replacing the conductive terminal 2 or rearranging the conductive terminals 2, so as to provide an easy replacement and lower the inspection cost.

In summation of the description above, the present invention adopts a structural design having a carrying base and a plurality of conductive terminals, wherein the conductive terminals having a high coefficient of elasticity are provided for contacting the contact points of the integrated circuits (IC) and the other electronic products, and a latch structure provided for separating the carrying base to achieve the effects of preventing the conductive terminal from being worn out or damaged easily, providing a convenient way of replacing the conductive terminal, protecting the contact points of the integrate circuits (IC) and the other electronic products, and improving the electric conductivity. In addition, the products of the invention can meet the market requirements, and the present invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A contact-type electronic inspection module, comprising: a carrying base, having a plurality terminal holes formed thereon; and a plurality of conductive terminals coupled to the terminal holes respectively, and both ends of the conductive terminal being exposed from upper and lower sides of the carrying base respectively, characterized in that the conductive terminal comprises an elastic pillar, and one or more electric conductive filaments buried in the middle of the elastic pillar, and the electric conductive filament includes an elastic portion disposed at a middle section of the electric conductive filament, and two conductive portions disposed at both ends of the electric conductive filament and exposed from both ends of the elastic pillar respectively.

2. The contact-type electronic inspection module of claim 1, wherein the elastic portion of the electric conductive filament of the conductive terminal is a spiral structure.

3. The contact-type electronic inspection module of claim 1, wherein the conductive portions at both ends of the electric conductive filament of the conductive terminal are plates bent from both ends of the elastic pillar respectively.

4. The contact-type electronic inspection module of claim 1, wherein the elastic pillar of the conductive terminal is made of a silicone-based material or a polymer material.

5. The contact-type electronic inspection module of claim 1, wherein the elastic pillar of the conductive terminal is a pillar having an upper end surface, a lower end surface and a lateral surface, and the upper end surface is exposed from a top side of the carrying base, and the lower end surface is exposed from a bottom side of carrying base, and the lateral surface has a protrusion latched into the terminal hole of the carrying base, and a conductive portion formed separately at both ends of the electric conductive filament and exposed from the upper end surface and the lower end surface of the elastic pillar respectively.

6. The contact-type electronic inspection module of claim 5, wherein the terminal hole of the carrying base has an inwardly retracted step surface disposed proximate to the upper end, and the lower end of the protrusion of the elastic pillar is abutted against the step surface.

7. The contact-type electronic inspection module of claim 5, wherein the carrying base includes a fixing element coupled thereon, and the fixing element includes a through hole corresponding to each terminal hole, and the elastic pillar is passed through the through hole, such that the upper end surface is exposed from the top side of the fixing element, and an edge of the through hole is abutted against the upper end of the protrusion of the elastic pillar.

8. The contact-type electronic inspection module of claim 7, wherein the carrying base includes a groove disposed thereon, and the terminal hole is disposed in the groove, and the fixing element is coupled into the groove.

9. The contact-type electronic inspection module of claim 7, wherein the carrying base includes a positioning protrusion disposed thereon, and the fixing element includes a positioning recession coupled to the positioning protrusion.
